(19) United States
(12) Patent Application Publication
(10) Pub. No.: US 2015/0109430 A1
(43) Pub. Date: Apr. 23, 2015

(54) DIGITAL IMAGING SYSTEM FOR BIOPSY INSPECTION

(71) Applicant: HISTOINDEX PTE LTD, Singapore (SG)

(72) Inventors: Hao Li, Singapore (SG); Hoe Yiin Leong, Singapore (SG)

(21) Appl. No.: 13/261,947

(22) PCT Filed: Feb. 25, 2013
(86) PCT No.: PCT/SG2013/000076

§ 371 Date: Aug. 29, 2014

(30) Foreign Application Priority Data
Feb. 23, 2012 (SG) 201201290-2

(51) Int. Cl. G02B 21/06; G02B 21/36; G02B 21/34

(52) U.S. Cl. CPC G02B 21/06; G02B 21/34; G02B 21/36; G02B 21/365
USPC 348/79; 359/385

(57) ABSTRACT

A self-illuminating microscope slide with a biopsy specimen disposed thereon comprises LEDs on the ends of the slide to illuminate the specimen through total internal reflection. A camera device captures a single digital image of the entire specimen in high resolution and large field of view encompassing the specimen.

### FIELD OF THE INVENTION

The present invention is in the field of histological specimen illumination and imaging.

### BACKGROUND OF THE INVENTION

The present invention is in the technical field of histology. More particularly, the present invention is directed to a system of illumination and digital image capturing techniques on histological specimens with a microscope.

Inspection of histological specimens with large planar sectional areas is essential in the fields of biology and medicine. The site of interest in a histological specimen needs to be quickly located in order to make a pre-evaluation of the specimen before proceeding on further to a comprehensive examination of the specimen. The histological specimen is typically placed on a standard microscopic slide with a top cover slip.

Conventional illumination methods for Microscopes use a consolable lamp mounted on the base of a microscope to illuminate a specimen located on a microscopic slide axially above the lamp, or a mirror to reflect light towards the specimen from an external light source. Conventional digital imaging methods for microscopes use a camera located axially above the specimen to capture images of the specimen through the microscope objective lens. The camera can have a field of view large enough to capture the entire specimen, or a smaller field of view to capture a digital image of the specimen with a higher axial resolution. Hence, a large field of view will lead to a low axial resolution and a small field of view will lead to a high axial resolution.

Digital images of the specimen captured with a camera in conjunction with either one of the two above-mentioned illumination methods tend to be affected by one or more of the following conditions: low contrast, strong background noise, saturated spots due to background illumination, and labels becoming invisible due to glare. In particularly, digital images of the specimen captured using a camera with a large field of view look transparent and difficult to be distinguished from the background of the glass microscopic slide. Digital images of the specimen captured using a camera with a smaller field of view in order to view through the microscope objective lens results in digital image sizes in the magnitude of several hundred micrometres. In order to obtain a complete digital image of the specimen, hundreds of digital images of a small section of the specimen have to be stitched together. This stitching process is costly as it requires complicated hardware to position the camera at specific locations above the specimen, software to process the digital images, and an extensive length of time to process. The stitched complete digital image may also be affected by optical aberrations.

The time-consuming process of stitching digital images is undesired because of the high frequency of operations in evaluating histological specimens in a medical environment. The optical defects in the resultant images make it difficult for users to properly assess and evaluate the specimens. These optical defects are amplified if the histological specimen is thin, transparent but turbid, and has a large planar sectional area. It is therefore desirable to provide a solution to address at least one of the foregoing problems described above.

### SUMMARY OF THE INVENTION

The present invention is a system and a method therefrom comprising an illumination device with a plurality of side light-emitting diodes (LEDs) to illuminate a histological specimen on a microscope slide, and a camera sensor to capture a single digital image of the same specimen.

### BRIEF DESCRIPTION OF THE DRAWINGS

FIG. 1 shows a partial front elevation of an internal illumination system according to an embodiment of the invention.

FIG. 2 shows a partial plan view of the internal illumination system of FIG. 1.

FIG. 3 shows a partial front elevation of a microscope slide of the internal illumination system of FIG. 1 with light scattering being generated by a biopsy specimen disposed thereon.

FIG. 4 shows an image of a biopsy specimen illuminated by the internal illumination system of the present invention.

FIG. 5 shows a set of images of a biopsy specimen illuminated by the internal illumination system of the present invention in different distances and angles.

FIG. 6 shows a set of images a biopsy specimen illuminated by the internal illumination system of the present invention in different magnification levels.

FIG. 7 shows a schematic of a self-illuminating microscope slide device according to the embodiment of FIG. 1.

FIG. 8 shows an image flow path for generating and stitching together multiple preview images in the prior art.

FIG. 9 shows an image flow path of a process for an image preview method for generating preview images of biopsy samples illuminated by the self-illuminating microscope slide device of FIG. 7.

FIG. 10 shows a computer screenshot of how the digital image preview is used in the biopsy inspection software.

### DETAILED DESCRIPTION OF THE INVENTION

Embodiments of the present invention are directed to a system of illuminating a histological specimen using an illumination device with a plurality of light-emitting diodes located on the sides of the device, and using a camera sensor to capture a single digital image of the same specimen.

In the present invention, the term “specimen” corresponds to .a histological tissue sample used in biopsy inspection.

The specimen as defined herein is thin, transparent but turbid, and has a large planar sectional area. The term “LED(s)” corresponds to light-emitting diode(s) used in the illumination device.

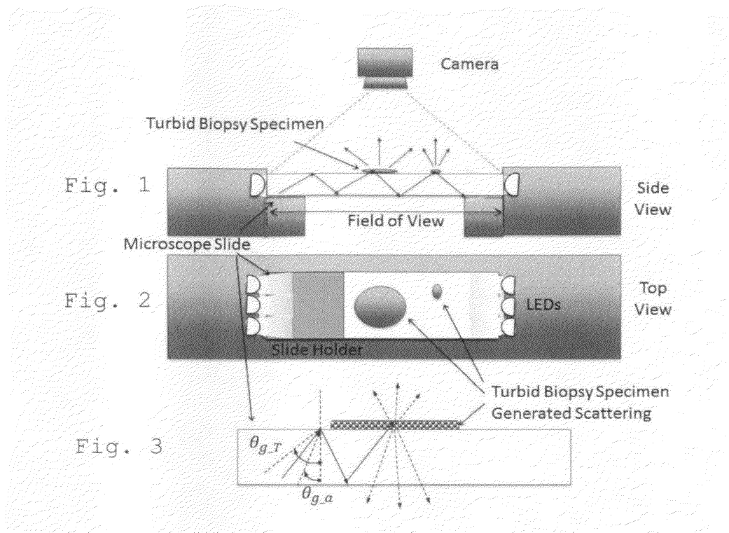

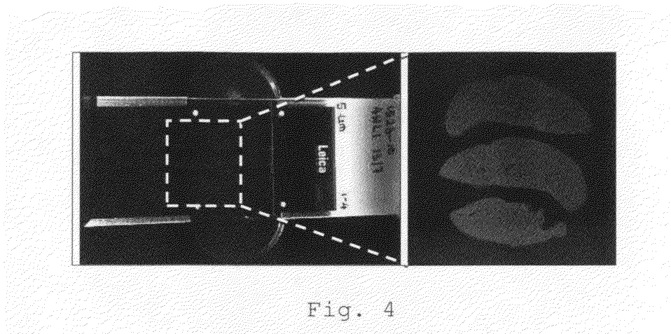

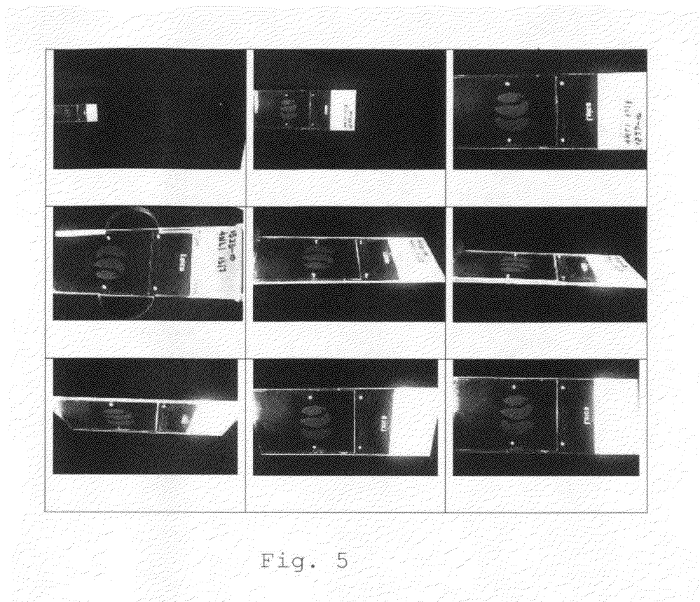

The illumination device comprises a glass microscopic slide with LEDs located at both longitudinal ends of the slide, as shown in FIG. 2. The specimen is disposed on top of the illumination device and illuminated by the LEDs. In FIG. 3, there is shown the angle of the illumination light from the

LEDs with respect to the axial axis of the illumination device, the angle satisfying the condition θ_{g-a}≦θ≦θ_{g-s}. θ_{g-a} and θ_{g-s} are the critical angles for total internal reflection at the glass-to-air interface and the glass-to-specimen interface, respectively.

In more detail in FIG. 1 and referring to the principle of total internal reflection, the illumination light traversing into the glass slide will be guided within the glass slide by the top and bottom interfaces between the glass slide and air, but not within the specimen because the total internal reflection condition is not satisfied in the interface between the glass slide and the specimen. Hence, the illumination light can enter into and scatter within the specimen because of the turbidity and strong scattering nature of the specimen.

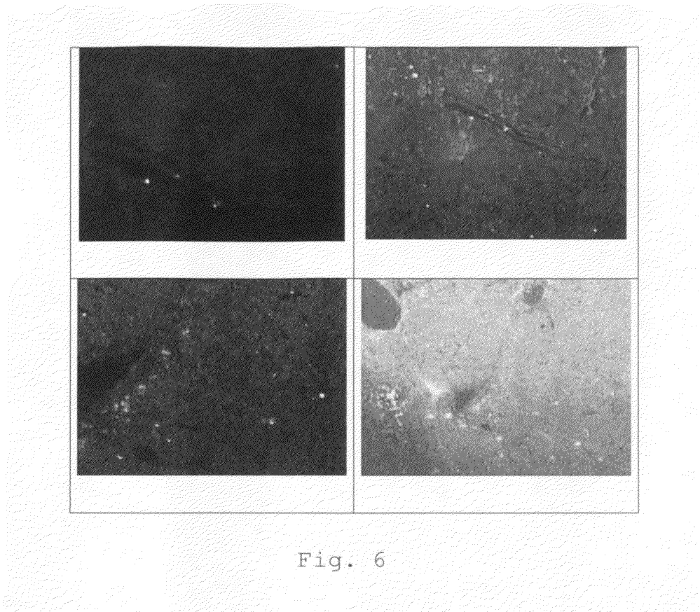

Compared with the glass slide and air which are homogenous and transparent, the specimen is turbid and the scattering of light is dominated by the specimen. The specimen is internally illuminated by the illumination device and acts as a light source for the capturing of digital images of the specimen. This removes the external light source which is used in prior art to illuminate the specimen either by way of direct axial illumination from the bottom, or by method of light reflection. The resolution of the digital images of the specimen is hence determined by the thickness of the specimen, instead of the objective lens of the microscope. The resolution of the digital image is independent of the field of view of the camera device. Therefore, a thinner specimen will be more transparent and allow more of the scattered light to pass through the specimen, giving a higher' resolution to the digital image obtained, as shown in FIG. 4.

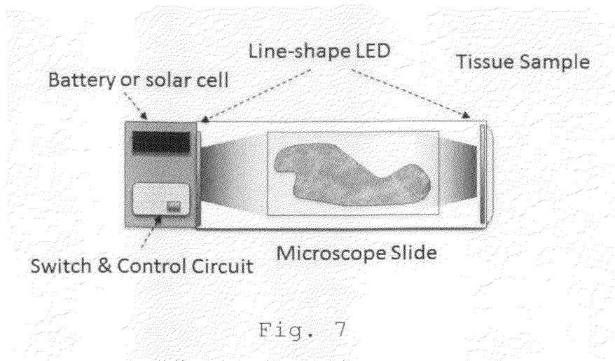

In the present invention, the quality of the digital images is determined by the conditions of the specimen, instead of the camera device or other optical devices. In FIG. 5, there is shown there is greater flexibility in that the digital images can be captured using the camera device from different distances, angles, and positions, without compromising the quality of the digital images. Moreover, the resolution of the digital images of FIG. 6 remains intact at different magnification levels. As the specimen is using its own illumination source, there is no necessity for any adjustment when integrating different camera devices with different specifications into the same imaging system.

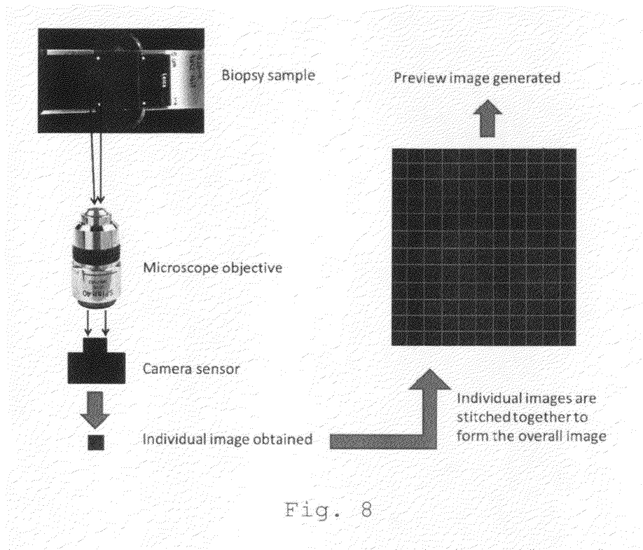

FIG. 7 shows a preferred embodiment of the present invention is a device, wherein the said device comprises of a microscope slide, LEDs on the two extreme ends, one integrated control circuit, and a battery source. This device can be used as a self-illuminating microscope slide for various purposes and inspections without the need for an external light source.

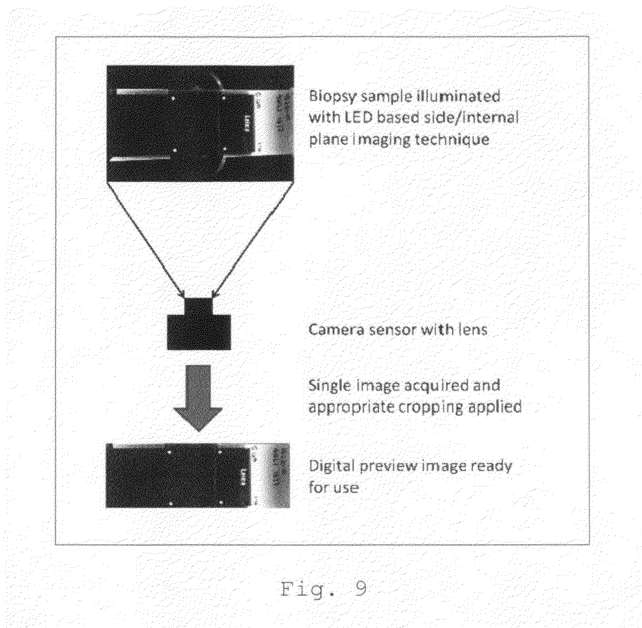

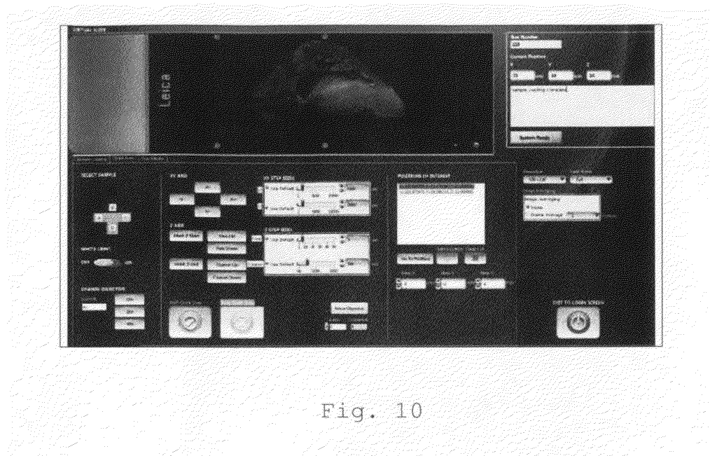

The digital image of the specimen is captured using a camera device with a field of view that encompasses the entire specimen. The specimen is illuminated by the self-illuminating microscope slide. In the prior art as shown in FIG. 8, multiple digital images of portions of the specimen have to be captured and stitched together, whereas in the present invention of FIG. 9, only one digital image is captured of the entire specimen.

As shown in FIG. 10, the digital image of the specimen is transmitted to and displayed in the system software as a preview image of the entire specimen. Users are able to use this digital image preview to navigate to locations of interest and perform detailed inspection at the desired magnification using the microscope objective lens. Users can select their desired location of interest and zoom into the location to obtain a digital image of that particular portion of the specimen. A grid as shown in FIG. 8 may be superimposed on the digital image preview and used as a reference table for users to select their desired locations of interest.

The advantages of the present invention include, without limitation, that it is compact and easily integrated in various optical imaging systems as a quick preliminary inspection tool for biopsy specimens. The specimen is internally illuminated via total internal reflection and allows for multiple optical detectors to capture images of the specimen under the same light source. The present invention enables the camera device to take a single digital image in high resolution and large field of view to encompass the entire specimen. As only a single digital image is captured, there is no stitching of multiple digital images involved and the processing time is reduced. The resultant digital images are free from shadows, of high contrast, and have greater clarity in the details of the specimen.

In broad embodiment, the present invention is a self-illuminating device that illuminates a biopsy specimen for inspection.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A system for inspecting a specimen, the system comprising an illumination device for disposing the specimen thereon, the illumination device comprising a plurality of light sources for illuminating the specimen,
wherein the light substantially permeates the illumination device;
wherein the light substantially permeates an interface between the illumination device and the specimen, the light entering into and scattering within the specimen; and
wherein the light substantially reflects off other interfaces of the illumination device.

2. The system as in claim 1, the specimen comprising a histological tissue sample.

3. The system as in claim 2, wherein the histological tissue sample is at least one of transparent and turbid.

4. The system as in claim 1, the illumination device further comprising an integrated control circuit and a battery source.

5. The system as in claim 1, the illumination device further comprising two opposing sides, wherein each side comprises at least one light source from the plurality of light sources.

6. The system as in claim 1, wherein each of the plurality of light sources comprises a light-emitting diode (LED).

7. The system as in claim 1, wherein the illumination device is made from a translucent material.

8. The system as in claim 7, wherein the translucent material is glass.

9. The system as in claim 1, the illumination device further comprising a microscope slide.

10. The system as in claim 1, the other interfaces being between the illumination device and air.

11. The system as in claim 1, further comprising a camera device for capturing an image of the specimen.

12. The system as in claim 11, the camera device capturing the image with a field of view substantially encompassing the specimen.

13. The system as in claim 1, the image being at least one of transmittable to and displayable on a computing device, wherein the image is displayable on the computing device as a digital image preview of the specimen.

14. The system as in claim 13, further comprising a grid superimposed on the digital image preview, each location in the grid corresponding to a portion of the digital image preview, wherein each portion of the digital image preview is at least one of selectable and magnifiable.

15. A method for inspecting a specimen, the method comprising:
providing an illumination device comprising a plurality of light sources for illuminating the specimen;
disposing the specimen on the illumination device;
capturing an image of the specimen with a camera device,
wherein the light substantially permeates the illumination device;
wherein the light substantially permeates an interface between the illumination device and the specimen, the light entering into and scattering within the specimen; and
wherein the light substantially reflects off other interfaces of the illumination device.

16. The method as in claim 15, wherein the specimen comprises a histological tissue sample.

17. The method as in claim 16, wherein the histological tissue sample is at least one of transparent and turbid.

18. The method as in claim 15, wherein the illumination device further comprises an integrated control circuit and a battery source.

19. The method as in claim 15, wherein the illumination device further comprises two opposing sides, each side comprising at least one light source from the plurality of light sources.

20. The method as in claim 15, wherein each of the plurality of light sources comprises a light-emitting diode (LED).

21. The method as in claim 15, wherein the illumination device is made from a translucent material.

22. The method as in claim 21, wherein the translucent material is glass.

23. The method as in claim 15, the illumination device further comprising a microscope slide.

24. The method as in claim 15, the other interfaces being between the illumination device and air.

25. The method as in claim 15, further comprising providing a camera device for capturing an image of the specimen.

26. The method as in claim 25, further comprising capturing the image with a field of view substantially encompassing the specimen.

27. The method as in claim 15, further comprising at least one of:
transmitting the image to a computing device; and
displaying the image on the computing device,
wherein the image is displayed on the computing device as a digital image preview of the specimen.

28. The method as in claim 27, further comprising at least one of:
selecting each portion of the digital image preview; and
magnifying each portion of the digital image preview,
wherein each portion of the digital image preview corresponds to a location in a grid; and
wherein the grid is superimposed on the digital image preview.
